(19) United States
(12) Patent Application Publication
(10) Pub. No.: US 2008/0244455 A1
(43) Pub. Date: Oct. 2, 2008

(54) OPERATING APPARATUS AND CONTROL METHOD OF THE SAME

(75) Inventors: Akira SETO, Fukuoka (JP); Masahiro KANAGAWA, Fukuoka (JP); Shinsuke SATO, Fukuoka (JP); Hitomi KINOSHITA, Fukuoka (JP); Takashi UCHIDA, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/855,412

(22) Filed: Sep. 14, 2007

(30) Foreign Application Priority Data
Mar. 30, 2007 (JP) 2007-093257

(51) Int. Cl. G06F 3/048

(52) U.S. Cl. 715/840

(57) ABSTRACT

An operating apparatus comprising: a display unit that has a first mode being capable of selecting a plurality of functions and a second mode being capable of selecting a part of the functions selectable in the first mode, and displays the functions selectable in the first mode when the first mode is selected and displays the functions selectable in the second mode when the second mode is selected; and a control unit that controls, when the second mode is transferred to the first mode, the display unit to display a function introduction screen for introducing a function which is not displayed in the second mode before the functions selectable in the first mode are displayed.

### BACKGROUND

The present invention is related to an operating apparatus for selecting functions while viewing a displayed menu, and a control method of the operating apparatus.

As conventional operating apparatuses for selecting functions which are wanted to be used by operators while viewing displayed menus, for example, JP-A-2003-51908 (Japanese Patent Laid Open) describes the below-mentioned communication apparatuses. That is, as to the communication apparatuses described in this patent publication, a facsimile apparatus equipped with a multifunction mode and a simple mode is disclosed as one example. In the multifunction mode, a large number of functions can be operated, whereas in the simple mode, a simple screen structure which may be readily understood by beginners is formed with a smaller number of functions than those of the multifunction mode.

As previously described, such operators who are inexperienced in operations select a desirable function in the simple mode with easy operations, whereas operators who wish to utilize complex functions select desirable functions in the multifunction mode. As a result, these operators can use the functions in correspondence with levels of their operators.

If operators who are inexperienced in operations operate communication apparatuses based upon display screens in simple modes, then these operators may use desirable functions to a certain degree, but these operators are required to operate the communication apparatus in the multifunction mode at a higher level. Nevertheless, even if the operators who are inexperienced in operations can understand such a fact that various sorts of convenient functions may be utilized in the multifunction mode, these inexperienced operators can hardly use the multifunction mode, and therefore, there is such a trend that these unexperienced operators may have feelings of satisfaction in the simple mode. When these unexperienced operators utilize such a function which is not provided in the simple mode even one time, the unexperienced operators may wish to use other functions of the multifunction mode. As a result, master degrees of these unexperienced operators may be gradually improved, so that these unexperienced operators may satisfactorily master complex operations.

### SUMMARY

The present invention has an object to provide an operating apparatus and a control method thereof, capable of improving a mastering degree of an operator in order that a convenient function can be effectively utilized.

An operating apparatus, according to an aspect of the present invention, comprises:

a display unit that has a first mode being capable of selecting a plurality of functions and a second mode being capable of selecting a part of the functions selectable in the first mode, and displays the functions selectable in the first mode when the first mode is selected and displays the functions selectable in the second mode when the second mode is selected; and

a control unit that controls, when the second mode is transferred to the first mode, the display unit to display a function introduction screen for introducing a function which is not displayed in the second mode before the functions selectable in the first mode are displayed.

Further, a control method of an operating apparatus, according to another aspect of the present invention, is featured by such a method of controlling an operating apparatus having a first mode capable of selecting a plurality of functions and a second mode capable of selecting a part of the functions selectable in the first mode, the method comprising:

displaying the functions selectable in the first mode when the first mode is selected and displaying the functions selectable in the second mode when the second mode is selected; and

displaying, when the second mode is transferred to the first mode, a function introduction screen for introducing a function which is not displayed in the second mode before the functions selectable in the first mode are displayed.

As a result, the mastering degree of the operator can be improved in such a manner that convenient functions can be effectively utilized.

### BRIEF EXPLANATION OF THE DRAWINGS

FIG. 1 shows a diagram for showing an entire arrangement of a printer system according to an embodiment 1 of the present invention.

FIG. 2 shows an outer view for representing a printer apparatus shown in the printer system of FIG. 1, according to the embodiment 1 of the present invention.

FIG. 3 shows a block diagram for representing an arrangement of the printer apparatus of the printer system according to the embodiment 1 of the present invention.

FIG. 4 shows a block diagram for indicating an arrangement of a control unit of the printer system according to the embodiment 1 of the present invention.

FIG. 5 shows a diagram for indicating an example of a display screen as to a standard mode of the printer system according to the embodiment 1 of the present invention.

FIG. 6 shows a diagram for indicating an example of a display screen as to a simple mode of the printer system according to the embodiment 1 of the present invention.

FIGS. 7A, 7B and 7C show diagrams for showing examples of a function introduction screen of the printer system according to the embodiment 1 of the present invention.

FIG. 8 shows a diagram for sowing an example as to a display priority order changing screen of the printer system according to the present invention.

FIG. 9 shows a diagram for representing an example as to a function table of the printer system according to the embodiment 1 of the present invention.

FIGS. 10A and 10B show diagrams for indicating an example as to a pre-cut sheet and a function introduction screen displayed when the pre-cut sheet is prepared in the printer system according to the embodiment 1 of the present invention.

FIGS. 11A and 11B show diagrams for showing an example as to a function introduction screen for introducing a calendar print of the printer system according to the embodiment 1 of the present invention.

FIGS. 12A and 12B show diagrams for showing an example as to a function introduction screen for introducing an enlargement function and another function introduction screen for introducing a rotation function in the printer system according to the embodiment 1 of the present invention.

FIG. 13 shows a diagram for showing an example as to a function introduction screen for introducing an optional function of the printer system according to the embodiment 1 of the present invention.

### DETAILED DESCRIPTION

### Embodiment 1

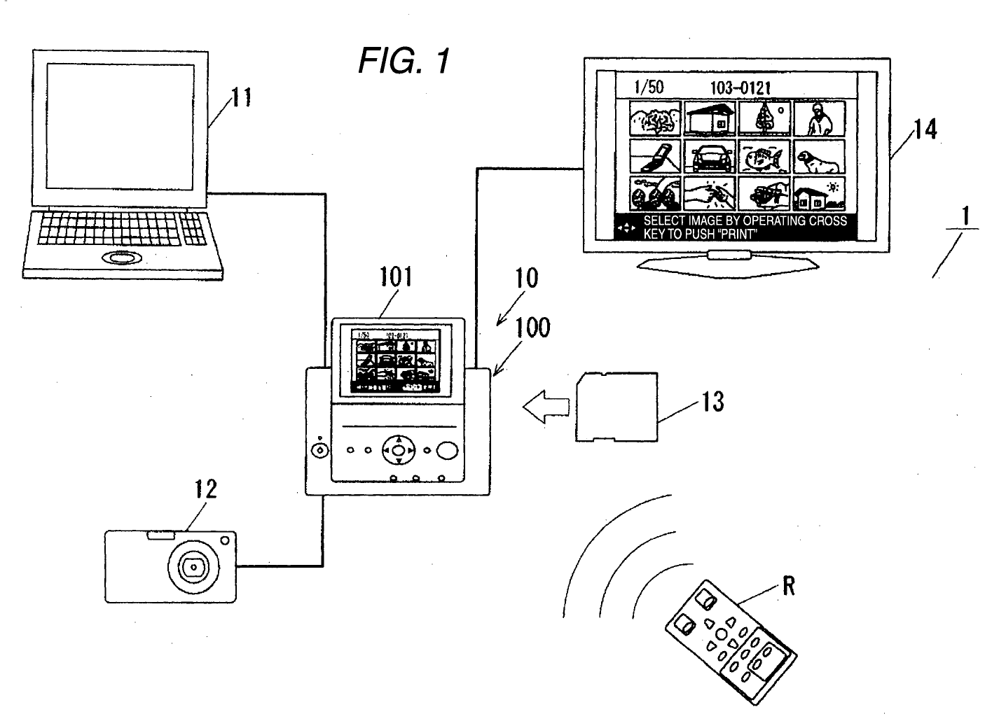

An operating apparatus according to an embodiment 1 of the present invention will now be described with reference to drawings, while a printer apparatus is employed as an example. Firstly, an entire arrangement of a printer system 1 according to the embodiment 1 will now be explained with reference to FIG. 1. FIG. 1 shows a diagram for showing the entire arrangement of the printer system 1 according to the embodiment 1 of the present invention.

As indicated in FIG. 1, the printer system 1 corresponds to such a system that image data is transferred from a personal computer (will be referred to as “PC” hereinafter) 11 and/or a digital camera (will be referred to as “DSC” hereinafter) 12 to an apparatus main body 100 of a printer apparatus 10, and further, a memory card 13 is inserted in the apparatus main body 100 so as to directly transfer image data, and then, the transferred image data is printed.

Further, in the printer apparatus 10, since a monitor apparatus 14 is connected to the apparatus main body 100, image data may be displayed not only on a liquid crystal panel (will be referred to as “LCD” hereinafter) 101 provided on the apparatus main body 100, but also the same display screen as the image data displayed on the LCD 101 may be displayed on the monitor apparatus 14. As the monitor apparatus 14, a general-purpose television receiver may be used. When a television receiver is employed as the monitor apparatus 14, a video output connector of the apparatus main body 100 is connected to a video input connector of the television receiver by a cable. Further, while the printer apparatus 10 is equipped with a remote controller “R”, the apparatus main body 100 can be operated by the remote controller “R.”

The printer apparatus 10 is connected to both the PC 11 and the DSC 12 by the USB (Universal Serial Bus) system, whereas the printer apparatus 10 is connected to the monitor apparatus 14 by way of the NTSC (National Television Standard Committee) system, the PAL (Phase Alternation by Line) system, or the like.

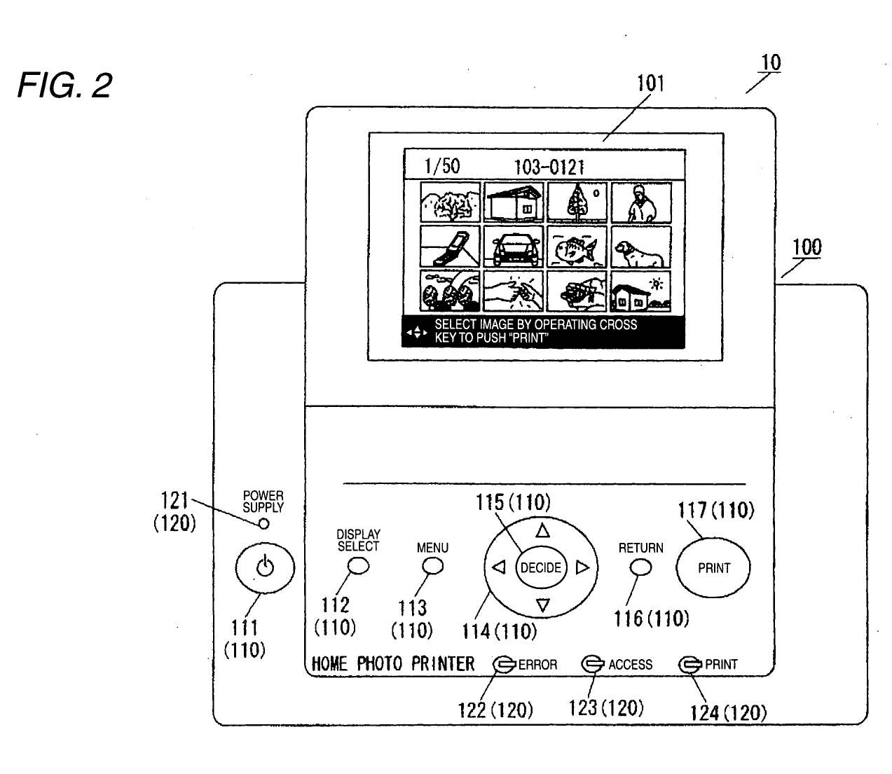

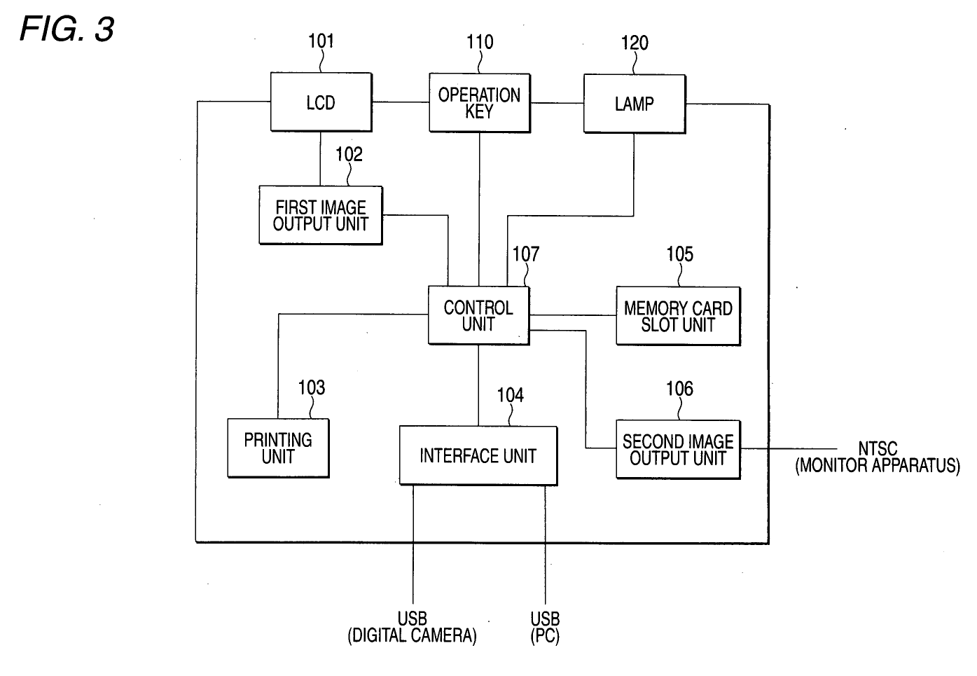

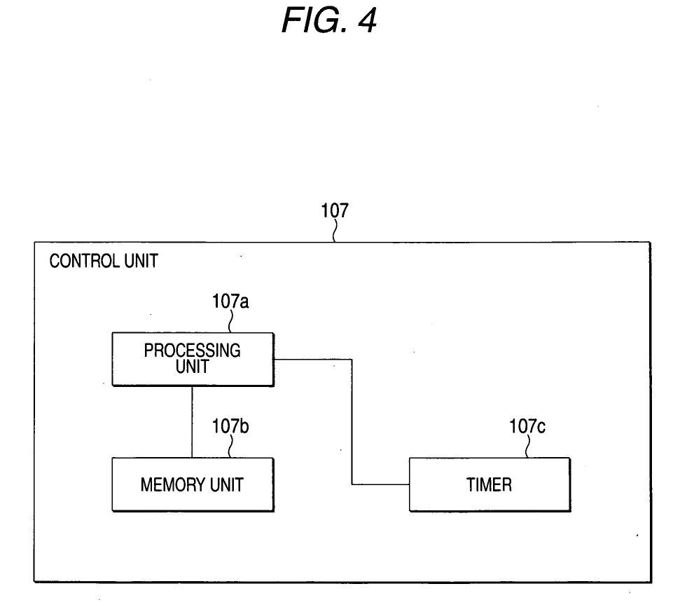

Next, a detailed description is made of an arrangement of the printer apparatus 10 based upon FIG. 2 to FIG. 4. FIG. 2 is an outer view for representing the printer apparatus 10 shown in the printer system 1 of FIG. 1, according to the embodiment 1 of the present invention. FIG. 3 is a block diagram for showing the arrangement of the printer apparatus 10. FIG. 4 is a block diagram for indicating an arrangement of a control unit employed in the printer apparatus 10.

As indicated in FIG. 2, the printer apparatus 10 is a sublimation type printer capable of printing recording sheets defined from a sheet having a size “L” (89 mm×119 mm) up to a sheet having a wide size (101 mm×180 mm) which is slightly larger than a size (101 mm×148 mm) of a postal card. As the LCD 101 provided on the apparatus main body 100, an LCD having a size of 3.5 inches (approximately 8.9 cm) has been employed, and a back light has been provided on the rear plane side of the LCD 101. The back light emits light so as to improve visual recognizability. Further, an operation key 110 for instructing operations and a lamp 120 for indicating statuses of the printer apparatus 10 have been provided on an upper plane of the printer apparatus 10.

As the operation key 110, the printer apparatus 10 has been provided with a “power supply” key 111, a “display switching” key 112, a “menu” key 113, a “cross” key 114, a “decision” key 115, a “return” key 116, and a “print” key 117.

The “power supply” key 111 corresponds to a key for instructing to turn ON and OFF the power supply of the apparatus main body 100. The “display switching” key 112 corresponds to such a key for switching that one image data among the respective image data being displayed on the LCD 101 is displayed in a large size, or displayed in a thumbnail display mode. The “menu” key 113 corresponds to a key which is depressed so as to display a menu. The cross key 114 corresponds to such a key that upper, lower, right, and left key portions having circular shapes are depressed so as to move a cursor for a selection purpose. The “decision” key 115 corresponds to a key which instructs to execute a content selected by the cross key 114. The “return” key 116 corresponds to a key which instructs to return to a previous screen. The “print” key 117 corresponds to a key which instructs a printing operation.

As the lamp 120, the printer apparatus 10 has been provided with a “power supply” lamp 121, an “error” lamp 122, an “access” lamp 123, and a “print” lamp 123, and a “print” lamp 124.

The “power supply” lamp 121 corresponds to such a lamp which indicates ON/OFF statuses of the power supply of the apparatus main body 100, and indicates a wait mode/stop mode. The “error” lamp 122 corresponds to a lamp which is turned ON when an error occurs in order to notify the error to an operator. The “access” lamp 123 corresponds to a lamp which indicates that image data is transferred from the PC 11, the DSC 12, or the memory card 13. The “print” lamp 124 corresponds to a lamp for indicating a status of “under printing operation.”

As shown in FIG. 3, a first image output unit 102, a printing unit 103, an interface unit 104, a memory card slot unit 105, a second image output unit 106, and a control unit 107 have been arranged in the apparatus main body 100.

The first image output unit 102 corresponds to a display output unit which inputs thereinto display data from the control unit 107 so as to convert the display data into a signal of an LCD interface, and then, outputs the converted signal to the LCD 101 corresponding to a display unit.

The printing unit 103 has been equipped with a thermal head, various sorts of motors, a gear group, a roller group, a sensor group, and the like in order to print image data on recording sheets stored in a paper cassette in response to an instruction issued from the control unit 107. Slots have been formed in the printing unit 103 so as to mount plural sorts of ink cassettes in correspondence with sizes of recording sheets to be printed. The sort of paper cassettes and the sort of ink cassettes are notified from the imprinting unit 103 to the control unit 107.

The interface unit 104 corresponds to such an interface employed so as to be connected to the PC 11, the DSC 12, and the like, which has been equipped with a USB port. In the embodiment 1, such a card slot capable of mounting an SD memory card (registered trademark) has been provided as the memory card slot unit 105. Alternatively, any card slots capable of mounting other memory cards may be employed. The second image output unit 106 corresponds to a display output unit which inputs thereinto display data from the control unit 107, and outputs the entered display data to the monitor apparatus 14 corresponding to a display unit. The second image output unit 106 has been provided with a video output connector to which a connection cable is connected in order to output a signal to the monitor apparatus 14. This second image output unit 106 converts display data from the control unit 107 into a display signal of the NTSC system, and then outputs the NTSC display signal.

As indicated in FIG. 4, the control unit 107 controls the entire arrangement of the apparatus main body 100 in a unification manner, while the control unit 107 has been equipped with a processing unit 107a, a memory unit 107b, and a timer 107c. This control unit 107 may be realized by a CPU (Central Processing Unit), a control circuit for controlling the CPU, a ROM (Read-Only Memory) into which a program, various sorts of setting programs, messages to be displayed, and the like have been previously stored, and further, a RAM (Random Access Memory) which is used as a work area of the program. In other words, while the ROM and the RAM function as the memory unit 107b, the CPU executes the program stored in the ROM corresponding to the memory unit 107b, so that the control unit 107 may function as the processing unit 107a which performs a process operation such as a printing operation, and another process operation such as a display operation. The messages to be displayed on the function introduction screen have been stored in the ROM corresponding to the memory unit 107b.

In the embodiment 1, a flash memory has been used as the ROM for storing thereinto a program in order to readily update the stored program. Further, a program to be stored is stored in the flash memory under compressed condition, and this stored program is expanded on the RAM during initial operation when the power supply is turned ON, and then, is executed by the CPU.

Alternatively, the timer 107c for measuring predetermined time may be realized by a software timer which measures time by executing the program, or by a hardware timer constructed of hardware.

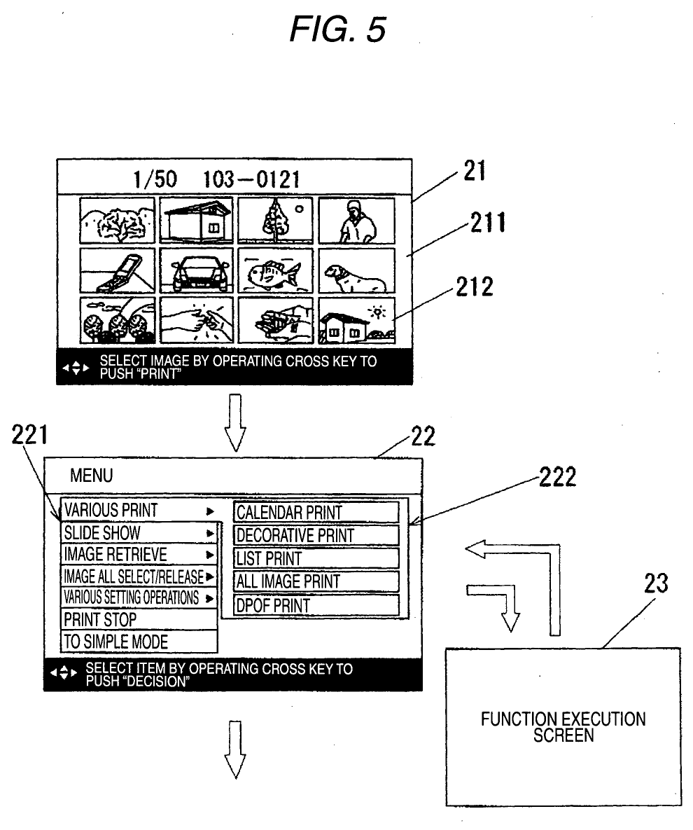

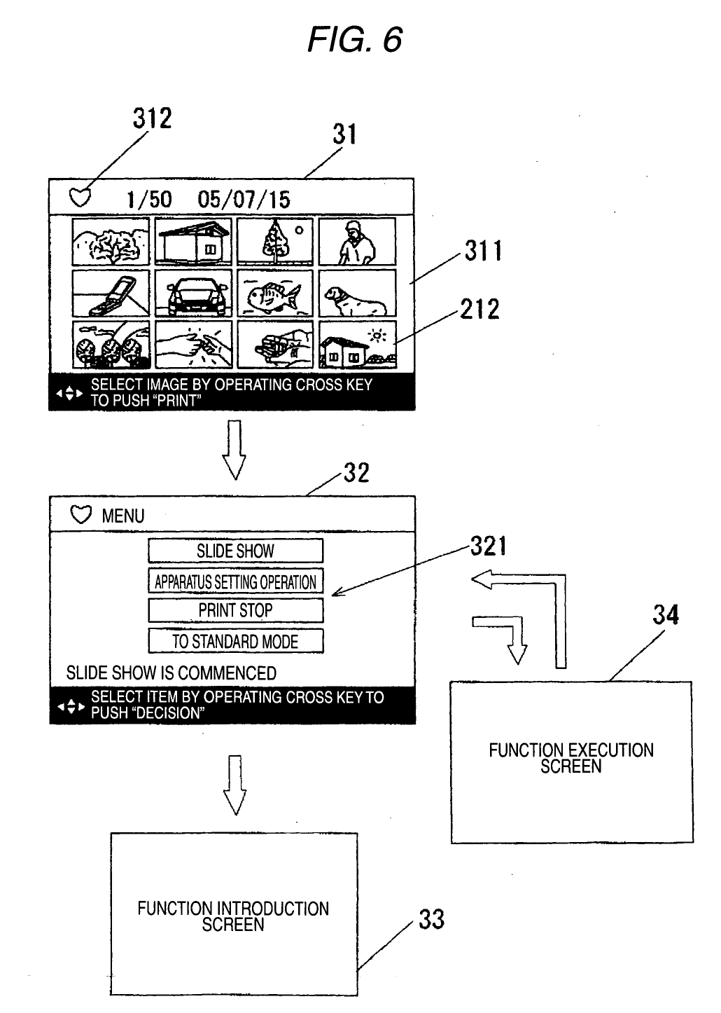

Referring now to drawings, a description is made of operations of the printer apparatus 10 according to the embodiment 1 of the present invention, which is arranged in the above-described manner. Firstly, both a standard mode and a simple mode will be explained with reference to FIG. 5 and FIG. 6. FIG. 5 is a diagram for showing an example of a display screen of the printer system 10 in the standard mode, according to the embodiment 1 of the present invention. FIG. 6 is a diagram for representing an example of a display screen in the simple mode.

As the operation modes of the processing unit 107a, there are: the standard mode (first mode) capable of selecting a plurality of functions, and the simple mode (second mode) capable of selecting plural functions which are smaller than all of the functions of the standard mode.

For the sake of easy descriptions, it is so assumed that in the embodiment 1, the printer apparatus 10 is initiated in the standard mode when the power supply is turned ON. However, if the operation mode of the processing unit 107a was the simple mode when the power supply was turned OFF in the previous operation time, then the printer apparatus 10 may be initiated in the simple mode when the power supply is turned ON in the next operation time. Further, it is so assumed that the memory card 13 into which image data photographed by the DSC 12, or the like had been stored has been mounted in the memory card slot unit 105.

Since the power supply is turned ON, the processing unit 107a reads the image data from the memory card 13 via the memory card slot unit 105, and then, outputs the read image data to both the first image output unit 102 and the second image output unit 106 as display data as display data so as to display the content of this image data on the LCD 101 and the monitor apparatus 14. FIG. 5 indicates the images displayed at this time.

On a standard mode list display screen 21 shown in FIG. 5, a background 211 has been displayed in a dark blue color, and images 212 read from the memory card 13 have been displayed in a list form. As indicated in a lower stage of the standard mode list display screen 21, since an operator operates the cross key 114 so as to move the cursor, the operator selects the image 212 and depresses the “print” key 117 so as to print the selected image 212. The selected image 212 is printed in such a manner that the processing unit 107a outputs the selected image data to the printing unit 103, so that a recording sheet is supplied from the paper cassette mounted on the printing unit 103 so as to print the image 212 on the supplied recording sheet. At this time the printing operation is such a standard printing operation as a silver salt photograph by printing the image data on the entire plane of the recording sheet.

Since the operator depresses the “menu” key 113 on the standard mode list display screen 21, a standard mode menu display screen 22 is displayed.

As to the standard mode menu display screen 22, a first hierarchical function menu 221 has been displayed on a left side, whereas a second hierarchical function menu 222 has been displayed on a right side. While the titles of functions such as “various prints”, “slide show”, and “image retrieve” have been displayed in the first hierarchical menu 221, a desirable function is selected by that the operator depresses the upper and lower portions of the cross key 114 so as to move the cursor along the upper and lower directions.

In the second hierarchical function menu 222, a detailed function of the first hierarchical function menu 221 is displayed by being blown out, at which the cursor is positioned.

If a function of the first hierarchical function menu 221 where the cursor is located corresponds to, for example, “various prints” as the second hierarchical function menu 222, then “calendar print”, “decorative print”, “list print”, and the like are displayed.

The operator depresses the right portion of the cross key 114 so as to move the cursor located on “various prints” to the right portion (second hierarchical function menu 222). Then, since the operator depresses the upper/lower portions of the cross key 114 so as to move the cursor along the upper and lower directions, the various functions such as “calendar print” and “decorative print” are selected. Then, since the operator depresses the “decision key” key 115, the function at which the cursor is positioned is executed.

The processing unit 107a outputs a function execution screen 23 to the first image output unit 102 and the second image output unit 106 as the display data in connection of the executions of the selected respective functions so as to display the display data on the LCD 101 and the monitor apparatus 14.

When the respective functions of the first hierarchical function menu 221 are selected on the standard menu mode display screen 22, in such a case that the operator selects “to simple mode” of the lowermost stage, the processing unit 107a transfers the status of the standard mode to the status of the simple mode.

In the simple mode, as shown in FIG. 6, firstly, a simple mode list display screen 31 is displayed. On this simple mode list display screen 31, a background 311 has been displayed in a light blue color, and an image 212 read from the memory card 13 has been displayed in a list form. This image 212 has the same content as the content displayed on the standard mode list display screen 21. The background 31 of the simple mode list display screen 31 is displayed in the light blue color which is different from the color of the background 211 of the standard mode list display screen 21, so that the operator can readily and visually recognize that the present mode is the simple mode. Alternatively, the present mode may be visually recognized as the simple mode by viewing an icon 212 shaped by a heart mark positioned on the upper left portion of the simple mode list display screen 31 with respective to such an operator who can hardly discriminate colors from each other. As displayed at the lower stage of the simple mode list display screen 31, the operator operates the cross key 114 so as to move the cursor, so that the image 212 is selected, and the operator depresses the “print” key 117 to print the selected image 212. At this time, the printing operation is performed in the standard printing operation.

On the simple mode list display screen 31, since the operator depresses the “menu” key 113, a simple mode menu display screen 32 is displayed.

A function menu 321 has been displayed at a center on the simple mode menu display screen 32. While the titles of the functions such as “slide show” and “apparatus setting operation” are displayed in the function menu 321, the operator depresses the “decision” key 115, so that such a function where the cursor is located is executed. In the standard mode, as the “various prints”, the functions such as “calendar print” and “decorative print” can be used which are displayed in either the first hierarchical function menu 221 or the second hierarchical function of the standard mode menu display screen 22. However, in the simple mode, these functions are excluded.

The processing unit 107a outputs a function execution screen 34 to the first image output unit 102 and the second image output unit 106 as the display data in connection of the executions of the selected respective functions so as to display the display data on the LCD 101 and the monitoring apparatus 14. There is such a case that this function execution screen 34 becomes equal to the function execution screen 23 displayed when the function is executed in the standard mode. There is another case that this function execution screen 34 is different from, for example, such a screen which is simplified in order that a detailed setting operation by the operator is not required.

When the respective functions of the function menu 321 are selected on the simple mode menu display screen 32, in such a case that the operator selects “to standard mode” located at the lowermost stage, the processing unit 107a moves the operation mode from the simple mode to the standard mode by displaying a function introduction screen 33.

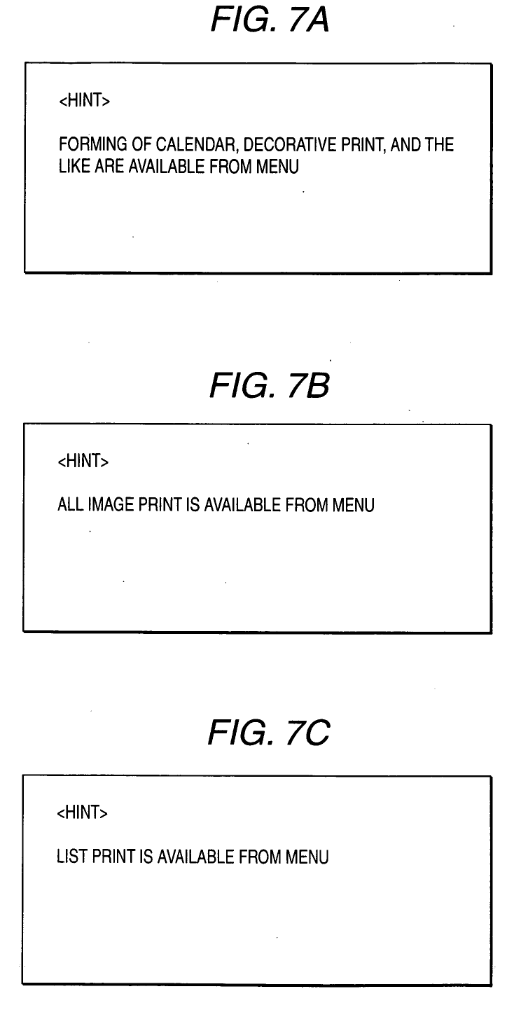

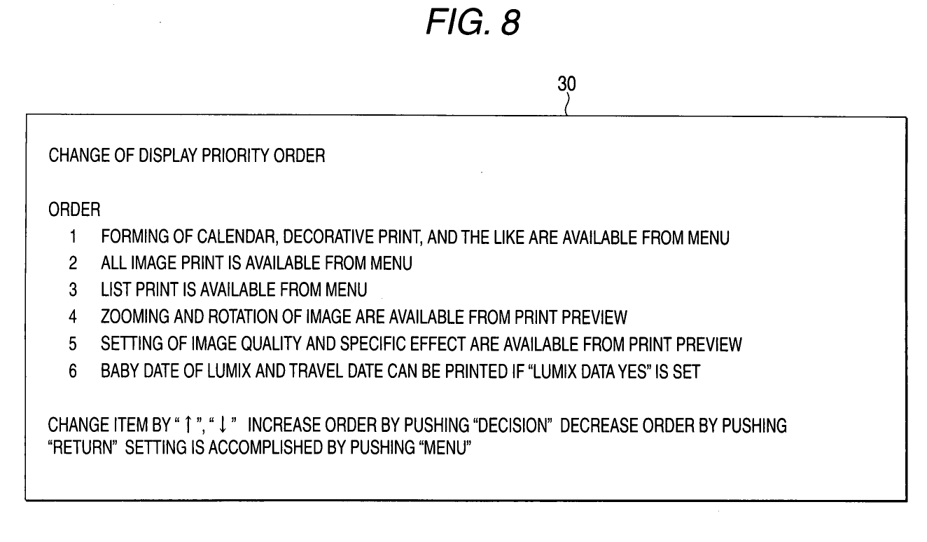

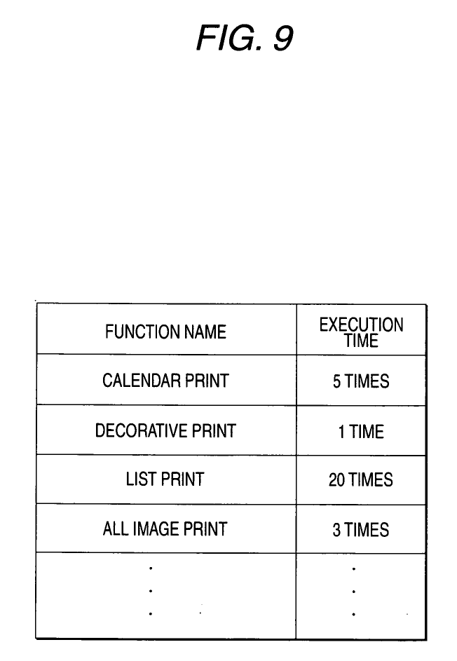

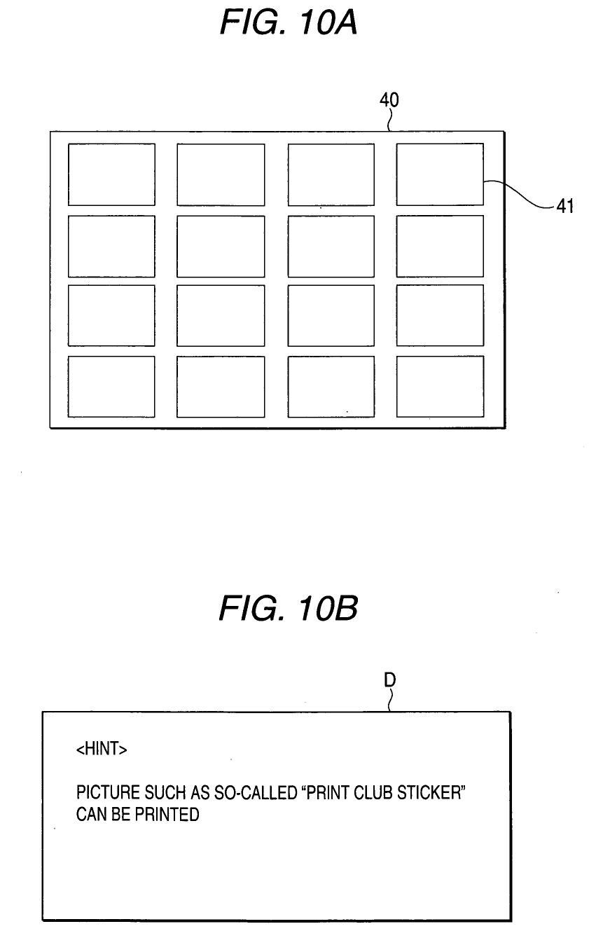

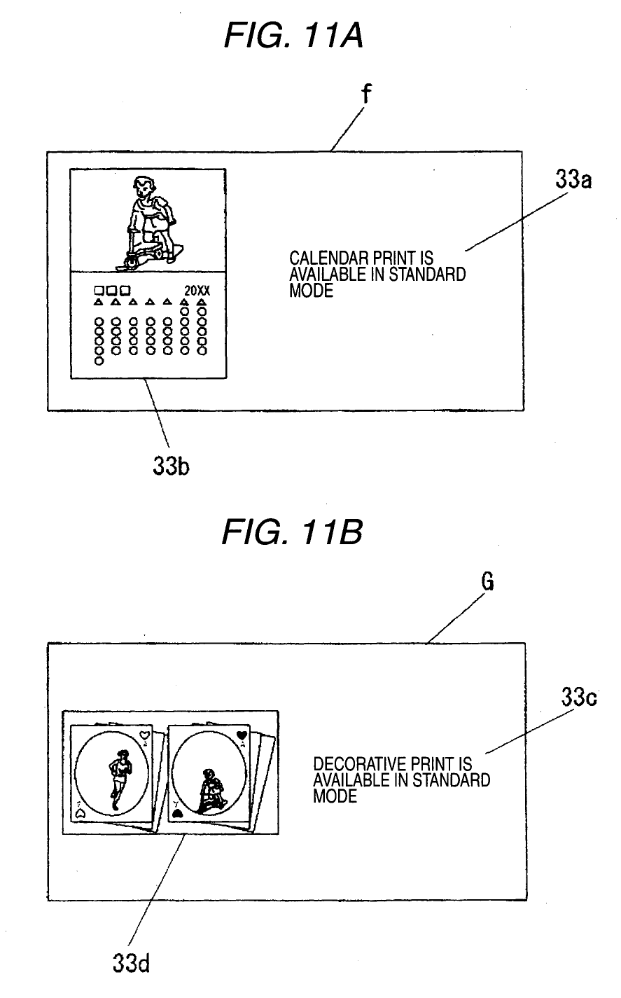

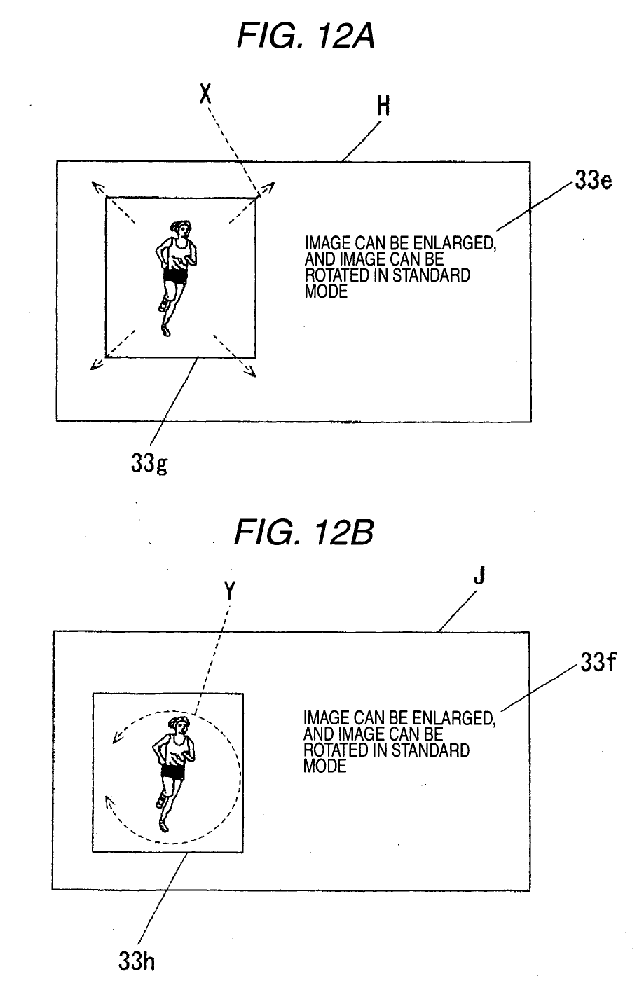

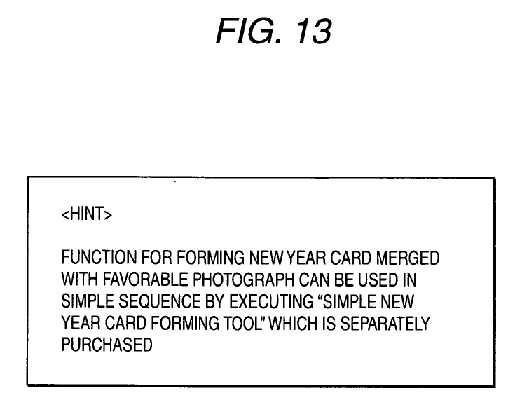

Now, a detailed description is made of the function introduction screen 33 which is outputted by the processing unit 107a when the operation mode is transferred from the simple mode to the standard mode with reference to FIG. 7A to FIG. 13. FIGS. 7A and 7C are diagrams for showing examples of the function introduction screen 33 of the printer system 1 according to the embodiment 1 of the present invention. FIG. 8 shows a diagram for showing an example as to a display priority order changing screen of the above-described printer system 1. FIG. 9 shows a diagram for representing an example as to a function table of this printer system 1. FIGS. 10A and 10B show diagrams for indicating an example as to a pre-cut sheet and a function introduction screen displayed when the pre-cut sheet is prepared in the printer system 1. FIGS. 11A and 11B show diagrams for showing an example as to a function introduction screen for introducing a calendar print of the printer system 1. FIGS. 12A and 12B show diagrams for showing an example as to a function introduction screen for introducing an enlargement (zooming) function and another function introduction screen for introducing a rotation function in the printer system. FIG. 13 shows a diagram for showing an example as to a function introduction screen for introducing an optical function of the printer system.

In the printing apparatus, as the function introduction screen 33 outputted by the processing unit 107a to the first image output unit 102 and the second image output unit 106, the below-mentioned display methods (1) to (7) can be selected:

(1) The function instruction image 33 is stored in the memory unit 107b in the unit of approximately 1 screen area, and fixed contents are displayed.

For instance, a function introduction screen “A” indicated in FIG. 7A is such a message “forming of calendar, decorative printing, and the like may be performed from menu.” The operator can know that if the operation mode is the standard mode, then “calendar print” and “decorative print” can be utilized from this function introduction screen “A”, while the operator cannot view “calendar print” and “decorative print” from the function menu 321 (refer to FIG. 6) of the simple mode. This function introduction screen “A” is displayed in a fixed manner when the status is shifted from the simple mode to the standard mode, so that a large memory capacity is not required. As a consequence, a memory section 107b having a large storage capacity need not be prepared in the memory unit 107b.

(2) As the function introduction screen 33, contents of this introduction screen 33 are different from each other every time this introduction screen 33 is displayed. For instance, firstly, the function introduction screen “A” represented in FIG. 7A is displayed, the status is shifted to the standard mode, and thereafter, the operation mode is returned from the standard mode to the simple mode. Again, when the status of the simple mode is shifted to the standard mode, such a function introduction screen “B” shown in FIG. 7B is displayed. Further, subsequently, a function introduction screen “C” shown in FIG. 7C is displayed.

This display order may be outputted by that these function introduction screens are outputted based upon such an order which has been previously set in the memory unit 107b, or based upon contents which are set in “various setting operation” selectable on the standard mode menu display screen 22, or based upon contents set by “apparatus setting operation” selectable on the simple mode menu display screen 32. For instance, as indicated in FIG. 8, the processing unit 107a may output the display priority order change screen 33, and may cause the operator to operate the operation key 110 so as to determine the display priority order. As previously explained, the functions different from the preceding functions are introduced, so that the functions can be introduced to the operator, which may conduct motivation of the operator who tries to use the various functions.

(3) The functions which are introduced via the function introduction screen 33 are introduced in an order of less execution time. While such a function table as indicated in FIG. 9 is provided in the memory unit 107b, every time the processing unit 107a executes the respective functions, an execution time is added. For instance, since the execution time of the function “decorative print” is the smallest value in the function table shown in FIG. 9, the function introduction screen “A” (refer to FIG. 7A) for introducing “decorative print” as the function introduced on the function introduction screen 33 is displayed in a top priority. Then, after the function introduction screen (A) is displayed and the status is shifted to the standard mode, when the status is returned from the standard mode to the simple mode and the status is again shifted from the simple mode to the standard mode, the function introduction screen B (refer to FIG. 7B) is displayed which introduces the function “all image print” having the second smallest execution number. As previously described, since the functions are introduced in the order of less execution time, such functions having low use frequencies may be actively introduced to the operator.

(4) The functions which are introduced via the function introduction screen 33 are introduced in an order selected at random. The processing unit 107a previously allocates a number with respect to each of functions. Then, the processing unit 107a introduces a function having such a number corresponding to the generated random number via the function introduction screen 33. As previously described, since various sorts of the functions are introduced to the operator in the order selected at random, it is possible to prevent a display formed with uniform functions.

(5) The functions which are introduced via the function introduction screen 33 are introduced in response to an apparatus environment. For instance, the function introduction screen 33 is outputted in response to both a sort of paper cassette and a sort of ink cassette, which are notified from the printing unit 103. When a recording sheet prepared in the paper cassette is such a pre-cut sheet 40 from which 4×4 sheet pieces 41 can be stripped as seals (refer to FIG. 10A), such a function introduction screen C as shown in FIG. 7C, another function introduction screen D, and the like are displayed in a top priority. The function introduction screen D indicates “so-called “print club sticker” printing is available” as indicated in FIG. 10B. Further, as to a sheet having an L size and a small printing area, it is not suitable to execute the function “list print” for either 5×5 images or 5×6 images are printed. As a consequence, when a sheet prepared in a paper cassette is either a sheet having an L size or a sheet having a size of a postal card, the priority order for displaying the function introduction screen C is lowered. As previously explained, since the function to be introduced is selected in response to the apparatus environment, the proper function can be introduced to the operator.

(6) As an explanation of a function which is introduced on the function introduction screen 33 image data is displayed which is obtained by processing such an image data which is transferred from the PC 11, the DSC 12, or the memory card 13 by the operator. For instance, as represented in FIG. 11A, when a function which is introduced via a function introduction screen F corresponds to the function “calendar print”, such an image data obtained by processing the transferred image data based upon “calendar print” is displayed as an explanatory image 33b in combination with an explanatory sentence 33a of “calendar print.”

Further, as shown in FIG. 11B, when a function which is introduced via a function introduction screen G corresponds to the function “decorative print”, such an image data obtained by processing the transferred image data based upon “decorative print” is displayed as an explanatory image 33d in combination with an explanatory sentence 33c of “decorative print.”

Further, in such a case that as shown in FIG. 12A, a function which is introduced via a function introduction screen H corresponds to an enlargement function, or as indicated in FIG. 12B, a function which is introduced via a function introduction screen J corresponds to a rotation function, transferred image data is processed in such a manner that this transferred image data is enlarged along an arrow “X” (refer to FIG. 12A), or is rotated along an arrow “Y” (refer to FIG. 12B), and then, the processed image data is displayed as an explanatory moving picture 33g, or an explanatory moving picture 33h in combination with an explanatory sentence 33e for introducing the enlargement function, or an explanatory sentence 33f for introducing the rotation function. In this case, after the image of FIG. 12A has been displayed for predetermined time, the image of FIG. 12B is subsequently displayed. Since the different function introduction screens are displayed in the continuous manner, the impact given to the operator can be increased.

As previously explained, since the image data which has been photographed by the operator herself is processed and then the processed image is displayed as the sample, the operator can readily grasp how the function which has not yet been used by this operator is operable in a concrete manner. Further, the condition (enlarge and rotate) under which the image data is processed is displayed as the moving picture. As a result, the appealing degree with respect to the operator can be improved.

(7) Further, as the function introduction screen 33, an optional function which has not yet been installed at the present time is introduced. For example, as shown in FIG. 13, a function for printing new year cards, which may be executed by being separately purchased, is displayed as such a function introduction screen K for introducing the optional function. This function introduction screen K can be displayed by that the processing unit 107a compares a list of functions installed in the memory unit 107b with another list of functions which can be executed if these functions are installed. This optional function is provided in such a manner that the memory card 13 into which the optional function has been stored is purchased, and then, the purchased memory card 13 is inserted into the memory card slot unit 105 so as to install the purchased optional function. As previously described, such a function which may be processed by the processing unit 107a in the standard mode and further has not yet been installed is introduced by the function introduction screen E. As a result, the display of this optional function may cause the operator to have a strong motivation of adding such a new function.

The function introduction screen 33 is displayed in accordance with the above-described methods (1) to (7), which may cause the operator to have the strong motivation capable of using the function which is not listed in the simple mode. As a consequence, while the functions which are not listed in the simple mode are selected in the standard mode and the selected functions are used, the mastering degree of the operator can be improved, so that the operator may also utilize the complex function.

Moreover, the processing unit 107a can automatically switch the function introduction screen 33 to the standard mode list display screen 21 after the function introduction screen 33 has been displayed only for a predetermined time. In this case, the present display time is measured by the timer 107c, and at a time when a time has elapsed, the display screen is switched to the standard mode list display screen 21. Since the function introduction screen 33 is outputted only for the predetermined time, the operator can transfer the status of the simple mode to the standard mode without any cumbersome operation.

Alternatively, the function introduction screen 33 may be switched to the standard mode list display screen 21 at such a time when the operator operates any key of the operation key 110 except that the function introduction screen 33 is automatically switched to the standard mode list display screen 21. As a result, the output of the function introduction screen 33 is continued unless the operator operates the operation key 110. As a result, it is possible to avoid that the operator misses the function introduction screen 33, and thus, the operator can visually recognize the content thereof.

Further, if the operator manipulates the operation key 110, then the function display screen 33 is switched to the standard mode list display screen 21. Alternatively, even if the operator does not manipulate the operation key 110, since a predetermined time has passed, the function display screen 33 may be switched to the standard mode list display screen 21. This predetermined time may be set by the function “various setting operation” selectable on the standard mode menu display screen 22, or the function “apparatus setting operations” selectable on the simple mode menu display screen 32.

While the embodiment 1 of the present invention has been described in detail, the present invention is not limited only to the above-described embodiment. For example, since a voice generating unit may be alternatively provided in the printer apparatus 10 according to the embodiment 1, the processing unit 107a may alternatively output the function introduction screen 33, and may alternatively produce a message for introducing the functions so as to notify the introduced functions to the operator in voice.

It should also be noted that the function introduction screen is displayed when the status is transferred from the simple mode to the standard mode in this embodiment. Alternatively, when the printer apparatus 10 is initiated in the standard mode when the power supply is turned ON, the function introduction screen may be displayed. In this alternative case, an operator who is familiar with the various functions of the printer apparatus 10 uses the printer apparatus 10 and then turns OFF the power supply thereof, and thereafter, when another operator who is not so familiar with these functions uses the printer apparatus 10, the last-mentioned operator may have a desirable will to use such a function in the standard mode, which is not listed in the simple mode.

Further, the function introduction screen may be alternatively set not to be displayed. When the mastering degree of the operator is improved, if the function introduction screen is displayed even time the status is transferred from the simple mode to the standard mode, then the operator is forcible to view the same screen many times, and a lengthy time is required in the status transition, resulting in cumbersome conditions. As a consequence, the function introduction screen may be set not to be displayed by utilizing the function “various setting operations” (refer to FIG. 5), the function “apparatus setting operations” (refer to FIG. 6), or the like. As a result, such a cumbersome display of the function introduction screen may be brought into the non-display condition.

Many modifications and variations of the present invention are possible in the light of the above techniques. It is therefore to be understood that within the scope of the invention the invention may be practiced otherwise than as specifically described.

This application is based upon and claims the benefit of priority of Japanese Patent Application No. 2007-083257 filed on Mar. 30, 2007, the contents of which are incorporated herein by reference in its entirety.

What is claimed is:

1. An operating apparatus comprising:
a display unit that has a first mode being capable of selecting a plurality of functions and a second mode being capable of selecting a part of the functions selectable in the first mode, and displays the functions selectable in the first mode when the first mode is selected and displays the functions selectable in the second mode when the second mode is selected; and
a control unit that controls, when the second mode is transferred to the first mode, the display unit to display a function introduction screen for introducing a function which is not displayed in the second mode before the functions selectable in the first mode are displayed.

2. The operating apparatus according to claim 1, wherein the control unit displays the function selectable in the first mode on the display unit after the function introduction screen has been displayed for a predetermined time.

3. The operating apparatus according to claim 1, wherein the function introduction screen has a screen for introducing a plurality of functions; and the control unit displays the function introduction screen on the display unit every 1 function selected from the plurality of functions.

4. The operating apparatus according to claim 1, wherein the control unit introduces the functions to be introduced via the function introduction screen in accordance with a predetermined order.

5. The operating apparatus according to claim 1, wherein the control unit introduces the functions to be introduced via the function introduction screen in accordance with an order selected at random.

6. The operating apparatus according to claim 1, wherein the control unit introduces the functions to be introduced via the function introduction screen in accordance with an order of execution times of each function.

7. The operating apparatus according to claim 1, wherein the control unit introduces the functions to be introduced via the function introduction screen in accordance with a sort of paper cassette which is set on a recording unit.

8. The operating apparatus according to claim 1, wherein the control unit introduces the functions to be introduced via the function introduction screen in accordance with a sort of ink cassette which is set on a recording unit.

9. The operating apparatus according to claim 1, wherein the control unit displays an image on the display unit, which is formed by adding an image corresponding to the function to be introduced with respect to the function to be introduced via the function introduction screen.

10. The operating apparatus according to claim 1, wherein the control unit displays on the display unit, a screen for introducing a function which is selectable in the first mode and is not installed in the operating apparatus.

11. A recording apparatus comprising:
an operating apparatus according to claim 1; and
a printing unit for printing an image inputted from an external apparatus.

12. A method of controlling an operating apparatus having a first mode capable of selecting a plurality of functions and a second mode capable of selecting a part of the functions selectable in the first mode, the method comprising:
displaying the functions selectable in the first mode when the first mode is selected and displaying the functions selectable in the second mode when the second mode is selected; and
displaying, when the second mode is transferred to the first mode, a function introduction screen for introducing a function which is not displayed in the second mode before the functions selectable in the first mode are displayed.

13. A method of displaying a plurality of titles of functions in a first mode and a plurality of titles of functions in a second mode, the plurality of the titles of functions in the second mode being included in the plurality of the titles of the first mode, and the modes being shifted, the method comprising:
displaying the plurality of the titles of functions in the second mode, and
displaying information about the functions in the first mode, which are not included in the functions in the second mode, when the second mode shifts to the first mode.

14. The method of displaying according to claim 13, wherein the titles of functions are selectable to conduct the functions.

15. The method of displaying according to claim 13 further comprising displaying the plurality of the titles of functions in the first mode after displaying the information about the functions in the first mode.
